(19) United States
(12) Patent Application Publication
(10) Pub. No.: US 2026/0208536 A1
(43) Pub. Date: Jul. 23, 2026

(54) OPTIMIZED ARCHITECTURE OF A CIVIL ENGINEERING TIRE

(71) Applicant: COMPAGNIE GENERALE DES ETABLISSEMENTS MICHELIN, Clermont-Ferrand (FR)

(72) Inventors: VINCENT ESTENNE, Clermont-Ferrand (FR); STEPHANE LAURENT, Clermont-Ferrand (FR)

(21) Appl. No.: 19/137,189

(22) PCT Filed: Dec. 7, 2023
(86) PCT No.: PCT/EP2023/084771

§ 371 Date: Jun. 9, 2025

(30) Foreign Application Priority Data
Dec. 14, 2022 (FR) 2213289

(51) Int. Cl. B60C 9/09; B60C 9/04

(52) U.S. Cl. CPC B60C 9/09; B60C 2009/0433; B60C 2009/0458; B60C 2200/065

(57) ABSTRACT

A radial construction plant tire comprises two working layers (51, 52) and two hooping layers (41, 42), the extensible metal reinforcing elements of which form angles with absolute values at least equal to 5° and at most equal to 16° with the circumferential direction (XX′), each metal reinforcing element of each hooping layer (41, 42) being extensible and having a structural elongation at most equal to 1% and at least equal to 0.3%, and the tangent linear densities of the reinforcing elements of each hooping layer at 1.5% strain being at least equal to 75 KN/mm and at most equal to 160 KN/mm, the axial width of the hooping layer LF also being reduced depending on the pitches and the linear stiffness of the working layers.

The subject of the present invention is a radial tyre intended to be fitted to a heavy-duty construction plant vehicle, and the invention relates more particularly to the crown reinforcement of such a tyre.

Radial tyres intended to be fitted to a heavy-duty vehicle of construction plant type are designated within the meaning of the European Tyre and Rim Technical Organisation, or ERTRO, standard.

For example, a radial tyre for a heavy-duty vehicle of construction plant type, within the meaning of the European Tyre and Rim Technical Organisation, or ETRTO, standard, is intended to be mounted on a rim with a diameter at least equal to 25 inches. Although not limited to this type of application, the invention is described for a radial tyre of large size, which is intended to be mounted on a dumper, in particular on vehicles for transporting materials extracted from quarries or surface mines, by way of a rim with a diameter at least equal to 35 inches, possibly as much as 57 inches, or even 63 inches.

Since a tyre has a geometry exhibiting symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The circumferential direction is tangent to the circumference of the tyre.

In the following text, the expressions “radially inner/radially on the inside” and “radially outer/radially on the outside” mean “closer to” and “further away from the axis of rotation of the tyre”, respectively. “Axially inner/axially on the inside” and “axially outer/axially on the outside” mean “closer to” and “further away from the equatorial plane of the tyre”, respectively, with the equatorial plane of the tyre being the plane that passes through the middle of the tread surface and is perpendicular to the axis of rotation. “An element A axially on the inside of an element B by an axial distance D” means that the element A is closer to the equatorial plane than the element B and that the axial distance between the two elements is equal to the distance D. This type of phrase can be extended to the radial and the circumferential direction and the outer position versus the inner position of one or the other of the elements.

Generally, a tyre comprises a tread intended to come into contact with the ground via a tread surface, the two axial ends of which are connected via two sidewalls to two beads that provide the mechanical connection between the tyre and the rim on which it is intended to be mounted.

A radial tyre also comprises a reinforcement made up of a crown reinforcement radially on the inside of the tread and of a carcass reinforcement radially on the inside of the crown reinforcement.

The carcass reinforcement of a radial tyre for a heavy-duty vehicle of construction plant type usually comprises at least one carcass layer comprising metal reinforcers that are coated in a polymeric material of the elastomer or elastomeric type that is obtained by blending and is known as a coating compound. A carcass layer comprises a main part that connects the two beads together and is generally wound, in each bead, from the inside of the tyre to the outside around a usually metal circumferential reinforcing element known as a bead wire so as to form a turn-up. The metal reinforcers of a carcass layer are substantially parallel to one another and form an angle of between 85° and 95° with the circumferential direction.

The crown reinforcement of a radial tyre for a construction plant vehicle comprises a superposition of circumferentially extending crown layers radially on the outside of the carcass reinforcement. Each crown layer is made up of generally metal reinforcers that are parallel to one another and coated in a polymeric material of the elastomer or coating compound type.

A metal reinforcer is mechanically characterized by a curve representing the tensile force (in N) applied to the metal reinforcer as a function of its relative elongation (in %), known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ASTM D 2969-04 of 2014 (ASRM, “American Society for Testing and Materials”). A person skilled in the art can derive the stress from the force exerted on the reinforcer, using the steel cross section of the reinforcer.

The total elongation At of the metal reinforcer is, by definition, the sum of its elastic and plastic structural elongations (At=As+Ae+Ap), in particular at break when each of the elongations is non-zero. The structural elongation As results from the relative positioning of the metal threads making up the metal reinforcer under a low tensile force. The elastic elongation Ae results from the actual elasticity of the metal of the metal threads making up the metal reinforcer, taken individually, the behaviour of the metal following Hooke's law. The plastic elongation Ap results from the plasticity, i.e. the irreversible deformation beyond the yield point, of the metal of these metal threads taken individually. These different elongations and the respective meanings thereof, which are well known to a person skilled in the art, are described, for example, in the documents U.S. Pat. No. 5,843,583, WO2005/014925 and WO2007/090603.

Also defined, at any point on the stress-elongation curve of a metal reinforcer, is a tensile modulus, expressed in GPa, which represents the gradient of the straight line tangent to the stress-elongation curve at this point. In particular, the tangent tensile modulus of the elastic linear part of the stress-elongation curve is referred to as the tensile elastic modulus or Young's modulus.

Among the metal reinforcers, a distinction is usually made between elastic or extensible metal reinforcers, such as those used in the protective layers, and non-extensible or inextensible or inelastic metal reinforcers.

An extensible metal reinforcer, in its rubberized state and extracted from the tyre, is characterized by a structural elongation As at least equal to 0.3% and a total elongation at break At at least equal to 2.5%. Moreover, an extensible metal reinforcer has a tensile elastic modulus at most equal to 150 GPa, and usually between 40 GPa and 130 GPa.

An inextensible metal reinforcer, in its rubberized state and extracted from the tyre, is characterized by a total elongation At, under a tensile force equal to 10% of the force at break Fm, at most equal to 0.3%. Furthermore, a non-extensible metal reinforcer has a tensile elastic modulus usually between 150 GPa and 200 GPa.

Among the crown layers, a distinction is usually made between the protective layers, which make up the protective reinforcement, are radially outermost and comprise extensible reinforcing elements (or reinforcers), and the working layers, which comprise inextensible reinforcing elements that make up the working reinforcement and are radially comprised between the protective reinforcement and the carcass reinforcement.

The protective reinforcement, which comprises at least one protective layer, essentially protects the working layers from mechanical or physicochemical attack, likely to spread through the tread radially towards the inside of the tyre.

The protective reinforcement often comprises, for a tyre of construction plant type, two radially superposed protective layers formed of extensible metal reinforcers that are parallel to one another in each layer and crossed from one layer to the next, forming angles at least equal to 18° with the circumferential direction.

The working reinforcement, which comprises at least two working layers, has the function of belting the tyre and giving it stiffness and road holding. It absorbs both mechanical inflation stresses, which are generated by the tyre inflation pressure and transmitted by the carcass reinforcement, and mechanical stresses caused by running, which are generated as the tyre runs over the ground and are transmitted by the tread. It also needs to withstand oxidation and impacts and puncturing, by virtue of its intrinsic design and that of the protective reinforcement.

The working reinforcement usually comprises two radially superposed working layers formed of non-extensible metal reinforcers that are parallel to one another in each layer and are crossed from one layer to the next, forming angles at most equal to 65°, and preferably at least equal to 18° and at most equal to 45°, with the circumferential direction. To reduce shear stresses in the rubber compounds, or rubber mixtures, at the axial ends of the working layers, it is commonplace to axially offset the position of said ends relative to one another. The crown reinforcement therefore usually comprises a working layer of larger axial width and a working layer of smaller axial width. The shear stresses in the rubber compounds are at a maximum at the end of the working layer of smaller axial width. This is because these maximum shear stresses, caused by the movements of the end of the working layer of smaller axial width, are distributed over the radial thickness of rubber compounds between the working layer of smaller axial width and the working layer of larger axial width. These shear stresses are amplified by the deformations of the working layer of larger axial width. This is because, given the angle of the metal reinforcers, which are crossed with the metal reinforcers of the working layer of smaller width, the working layer of larger axial width deforms in another direction, thereby increasing the deformations of the rubber compounds. These maximum shear stresses are generally reduced by adding a decoupling rubber between the end of the working layer of smaller axial width and the working layer of larger axial width. The end of the working layer of larger axial width is also subject to high shear stresses which are, however, generally of lower amplitude given that, for this end, the thickness of the rubber compounds is greater and the deformations are no longer amplified by the presence of the other working layer.

In order to reduce the mechanical inflation stresses and stresses caused by running that are transmitted to the working reinforcement and the shear stresses in the rubber compound covering it, it is known practice to dispose a hoop reinforcement radially on the outside of the carcass reinforcement. The hoop reinforcement, the function of which is to at least partially absorb the mechanical inflation stresses, improves the endurance of the crown reinforcement by stiffening the crown reinforcement. The hoop reinforcement can be positioned radially on the inside of the working reinforcement, between the two working layers of the working reinforcement, or radially on the outside of the working reinforcement. The absolute value of the angle of the reinforcing elements of the hooping layers with the circumferential direction XX′ is at least 5° and preferably 10° less than that of the angle of the reinforcing elements of the working layers, and the axial width of the hooping layers is also less than the axial width of the working layers.

In applications of construction plant type, the hoop reinforcement may comprise two radially superposed hooping layers formed of metal reinforcers that are parallel to one another in each layer and are crossed from one layer to the next, forming angles at most equal to 16° with the circumferential direction. In order to produce the hooping layers, on large-diameter construction plant tyres, the winding of a layer of discontinuous reinforcing elements, the ends of which extend from one axial edge of the layer to the other, forming an angle of between 7 and 16° with the circumferential direction, is often preferred to the winding of a narrow strip of several continuous reinforcing elements that form an angle of between 0° and 5° with the circumferential direction, for reasons of productivity. In both cases, the hooping layers have a smaller axial width than the working layer of smaller axial width. This is because the stresses caused by running at the end of the working layers are very high in tension and compression and result in the breakage of the inextensible metal reinforcers that are disposed around the ends and form angles of less than 16° with the circumferential direction. The document WO2019/202239 discloses a conventional architecture for construction plant tyres, comprising two hooping layers of stiff reinforcing elements, radially on the inside of two working layers of stiff reinforcing elements radially on the inside of extensible protective layers, the two hooping layers having an axial width substantially less than the axial width of the working layers. That document discloses optimizing the protective layers in order to improve the resistance to attacks on the crown to which construction plant tyres are subject. Specifically, construction plant tyres, and particularly those used in surface mines, are subject to attacks generally in the vicinity of the cutting face where the ore sticks out more. As the tread wears down, the impact of the indentation stiffness of the crown block on the cuts in the tread becomes apparent. Although the optimization proposed in the prior art has its benefits, the significant circumferential stiffness thereof, which is mainly provided by the hooping layers and mostly at the centre of the crown, is conducive to the tread becoming cut and wearing down unevenly at the centre, and sometimes to the complete puncturing of the crown block. It is well known to a person skilled in the art that increasing the mean angle of the hooping layers to above 16° makes it possible to reduce the circumferential tensile stiffness of the crown, but this accordingly reduces endurance by promoting cracks at the ends of the working layers, and also at the end of the hooping layers themselves.

The inventors set themselves the objectives, for a tyre for a heavy-duty construction plant vehicle, to have satisfactory endurance in particular at the ends of the crown layers, to improve the resistance of the crown reinforcement to puncturing, in particular in the central portion, and to increase the resistance of the tread to chunking caused by attacks.

This objective has been achieved, according to the invention, by a radial tyre for a heavy-duty construction plant vehicle, intended to be mounted on a nominal rim of radius R expressed in inches, comprising a crown reinforcement, radially on the inside of a tread and radially on the outside of a carcass reinforcement,
the crown reinforcement comprising a working reinforcement,
the working reinforcement (50) comprising at least two working layers, each comprising metal reinforcing elements that are coated in an elastomeric material, are parallel to one another, and form an angle at least equal to 18° and at most equal to 45° with the circumferential direction (XX′), said metal reinforcing elements being crossed from one working layer to the next,
the working layer of smallest axial width having an axial width LT in mm, and reinforcing elements that have a linear density MT in g/m and are disposed in the working layer with a mean pitch PT in mm,
the crown reinforcement comprising a hoop reinforcement comprising at least two hooping layers, each hooping layer comprising metal reinforcing elements that are coated in an elastomeric material, are parallel to one another, and form angles with absolute values at least equal to 5° and at most equal to 16° with the circumferential direction (XX′),
each reinforcing element of each of the layers of the crown reinforcement being characterized by a structural elongation, a total elongation at break and at least one tangent tensile modulus, these characteristics being measured in accordance with the standard ASTM D 2969-04 of 2014,
the reinforcing elements of each hooping layer having a metal linear density MF in g/m, a tangent modulus GF at 1.5% strain, and being disposed in the hooping layer with a mean pitch PF in mm, and each hooping layer having a tangent linear stiffness RF equal to (GF*MF/7.8)/PF,
each metal reinforcing element of each hooping layer being extensible, with a structural elongation AsF at most equal to 1% and at least equal to 0.3% and with a tangent linear stiffness RF at 1.5% strain at least equal to 75 KN/mm and at most equal to 160 KN/mm,
with the radially outermost hooping layer having an axial width LF, the width LF being at least equal to LT*[R/110.25+((GT/GF)*(MT/MF)/(PT/PF)+AsF*80-1)/8].

Contrary to the logic by which hooping layers are used, to absorb longitudinal forces, the solution consists in using extensible reinforcing elements for the hooping layer. Specifically, the challenge for an optimal hoop is that it withstands compression in particular during compression of the tyre and under transverse cornering forces in particular, along the transverse direction (YY′). On account of their behaviour under compression and their capacity to resist buckling, the extensible reinforcing elements are highly advantageous and digital simulations carried out show that, contrary to expectations, the extensible nature of the hooping reinforcing elements results in a non-negligible increase in endurance of the crown.

In addition to this improved resistance to compression, the use of extensible cords in the hooping layers makes it possible to very significantly and surprisingly improve the cracking resistance of the rubber compounds at the axial ends of the hooping layers, thereby resulting in a significant increase in endurance.

This solution is even more effective if, unlike many extensible reinforcing elements, in particular those commonly used for the protective layers, the hooping layers have tangent linear stiffnesses at least equal to 75 KN/mm and at most equal to 160 KN/mm at 1.5% strain. Considering only the stiffness of the reinforcing elements is not enough, since certain reinforcing elements, in particular those with small diameters, may satisfy an elementary stiffness condition, but prove to be incompatible with use in civil engineering once they are in layers. If the stiffness condition given in the invention is fulfilled, the absorption of forces in the tensile phase is much more effective than with the more extensible reinforcing elements and improves endurance. In addition, the extensible nature of the reinforcing elements improves endurance compared with the existing solution on the market, where the reinforcing elements would be inextensible.

One of the advantages of the use of extensible reinforcing elements for the hooping layers, given their greater resistance to compression and their lower tensile stiffness, is that it is possible, while maintaining adequate endurance, to increase their width compared with the width of the working layers. This increase in the width reduces the level of shear stresses in the rubber compositions at the ends of the working layers. Thus, the invention means that, with the radially outermost hooping layer having an axial width LF, and the reinforcing layers of the radially outermost hooping layer having a structural elongation AsF, the width LF is at least equal to LT*[R/110.25+((GT/GF)*(MT/MF)/(PT/PF)+AsF*80-1)/8]. This width makes it possible to influence the extensible hooping layers more substantially while limiting the width of the hooping layers and therefore the consumption of metal.

The extensible nature of the hooping layers is not incompatible with the use of extensible working layers. Hence, it is appropriate to adjust the design parameters in order to design a successful crown reinforcement and in particular the relative elasticities of the different crown layers via the type of reinforcing elements, their elasticities and their evolution under strain, their fatigue resistance and resistance to break, their pitches and their angles. Thus, an advantageous solution may be that each metal reinforcing element of each working layer is extensible and has a structural elongation AsT at least equal to 0.3%, a tangent modulus at 1.5% strain at most equal to 130 GPa and a total elongation at break at least equal to 2%.

Similarly, a solution may be found with working layers in which the reinforcing elements are inextensible, and thus one of the preferred solutions is that each metal reinforcing element of each working layer is inextensible and has a structural elongation AsT at most equal to 0.2% and a tangent modulus GT at 0.5% strain at least equal to 150 GPa.

Nevertheless, the optimal axial width LF of the hooping layers may be evaluated as being LT*[R/110.25+((GT/GF)*(MT/MF)/(PT/PF)+AsF*100-1)/7] and therefore one of the advantageous solutions is that the hooping layer of smallest axial width has an axial width LF equal to the optimal width plus or minus 10%.

Thus, it is advantageous that the hooping layer of smallest axial width has an axial width at least equal to 0.9*LT*[R/110.25+((GT/GF)*(MT/MF)/(PT/PF)+AsF*100-1)/7] and at most equal to 1.1*LT*[R/110.25+((GT/GF)*(MT/MF)/(PT/PF)+AsF*100-1)/7].

By contrast, to avoid breakage under compression of the hooping layers, it is preferred that each hooping layer has an axial width at most equal to the axial width LT of the working layer of smallest axial width.

It is advantageous that the crown reinforcement has two hooping layers for reasons of manufacturing cycle times and balance of the crown architecture, the angles formed by the reinforcing elements of the two hooping layers being of opposite signs. Such architectures are thus designed more for tyres for civil engineering vehicles and even more for construction plant tyres wherein the radius R of the nominal rim of the tyre is at least equal to 57 inches.

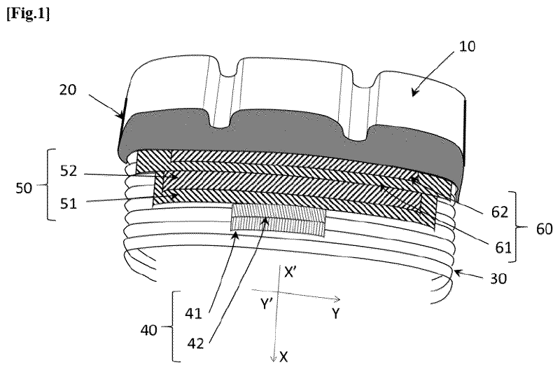

The characteristics of the invention are illustrated schematically and not to scale in FIG. 1, with reference to a tyre of size 59/80R63 .

FIG. 1 shows a cutaway perspective view of the crown of a tyre having:
sidewalls 20,
a carcass reinforcement 30 comprising a carcass layer, the reinforcers of which form an angle of close to 90° with the circumferential direction XX′,
a hoop reinforcement 40 comprising two hooping layers 41 and 42,
a working reinforcement 50 comprising two working layers 51 and 52 and radially on the outside of the hoop reinforcement 40,
a protective reinforcement 60 comprising two protective layers 61 and 62.

In the prior art, the working layers and the hooping layers are made up of inextensible reinforcing elements. In the tyres according to the invention, the working layers are made up of inextensible reinforcing elements and the hooping layers are made up of extensible reinforcing elements, the total elongation elongation At at break of which is at least equal to 2% and the tangent moduli of the reinforcing elements of each hooping layer at 1.5% strain is at least equal to 70 GPa and at most equal to 130 GPa.

The invention was compared with a commercially available control tyre (“Michelin 59/80R63 XDR3”) of the same size, the crown of which is made up of two hooping layers with axial widths of 520 mm and 580 mm, radially on the inside of two working layers with axial widths of 1006 mm and 926 mm, radially on the inside of two protective layers. The reinforcing elements of the hooping layers form angles of 8 and −8°. They are inextensible with a 77.35 configuration, that is to say 77 steel threads with a diameter of 35 hundredths of a millimetre, for a tensile modulus, measured on a cord removed from the tyre, equal to 178 GPa at 0.5% strain, and are disposed at a pitch of 5.5 mm, a linear density of 60.1 g/m or a tangent linear stiffness of 240 KN/mm. The reinforcing elements of the working layers form angles of −33 and 19°. They are inextensible with a 77.35 configuration, that is to say 77 steel threads with a diameter of 35 hundredths of a millimetre, for a tensile modulus, measured on a cord removed from the tyre, equal to 178 GPa at 0.5% strain, and are disposed at a pitch of 6.4 mm with a linear density of 60.1 g/m. They are inextensible. The reinforcing elements of the protective layers are extensible and form angles of 24 and 24°.

The mean pitches are measured on tyre sections. This is a measurement for crown layers that is conventional to a person skilled in the art. The linear density is measured on an element, from which the rubber has been removed chemically, of the reinforcing elements removed from the tyre either by measuring the metal cross section by image analysis and reconstruction by calculation.

The inventors first of all attempted to use, for tyres referred to as Test1, for the two hooping layers of the tyre, extensible reinforcing elements with 44 steel threads with a diameter of 35 hundredths of a millimetre, for a tensile modulus, measured on a cord removed from the tyre, equal to 1.5% strain at 50 GPa. These reinforcing elements have a diameter of 3.9 mm, a linear density of 36.7 g/m, a structural elongation AsF of 1.1% and are disposed at a pitch of 4.4 mm or a tangent linear stiffness of 54 KN/mm at 1.5% strain. Reducing the pitch in order to increase the tangent linear stiffness would cause increases in the shear stresses between the reinforcing elements and rapid cracking of the crown. They then produced a tyre according to the invention, Test2, in which the reinforcing elements of the hooping layers are extensible and made up of 7 strands comprising 21 steel threads with a diameter of 23 hundredths of a millimetre having tangent moduli at 1.5% strain equal to 95 GPa. These reinforcing elements have a diameter of 4.8 mm, a linear density of 53 g/m, a structural elongation AsF of 0.5% and are disposed at a pitch of 5.6 mm or a tangent linear stiffness of 118 KN/mm.

The control tyre and the tyres according to Test1 or Test2 are identical apart from the hooping layers. They have the same tread pattern and the same reinforcers for the carcass layer, the protective layers and the working layers, and the same rubber compounds for the different parts of the tyre.

The tyres were simulated on calculation tools. The simulations make it possible to evaluate the mechanical and thermal stresses exerted on tyres using the finite element method for large displacement and large strain, taking into account the mechanical and hysteretic properties of the materials.

The aim of the invention is to reduce the circumferential stiffness at the centre in order to improve wear and resistance to attacks and puncturing. The drop in stiffness is estimated from the deformation of the crown block under the effect of an increase in pressure.

For the versions Test1 and Test2, the stiffness at the centre of the crown was divided respectively by a factor of 3.4 and divided by 2.7 for the version according to the invention. The mean stiffness of the crown reinforcement is sufficient to absorb the running forces. This drop in stiffness at the centre should allow an increase in puncture resistance of between 20% and 40% depending on the breaking strength of the crown layers, and should help to overcome the problems of uneven wear caused by the excessive stiffness of the centre of the control construction plant tyre.

With respect to the endurance of the crown, the safety coefficients (breaking strength of the cord when subjected to maximum stresses) of the reinforcing elements of all of the crown layers are at least equal to the minimum safety coefficient of the control tyre.

With respect to the endurance of the rubber compositions at the ends of the radially outermost working layer, the use of extensible cords results in a maximum reduction in stress. With respect to the maximum energy density, this is doubled for the tyre according to the version Test 1 and increased by 50% for the tyre according to the version Test2. The tyre according to Test1 is not compatible with the endurance requirements of civil engineering use. By contrast, depending on the use of the tyres, the invention Test2 is possibly advantageous. This is because, while breakages caused by crown impacts are significant and much more likely that crown degradation caused by cracking of the rubber compositions of the crown, the tyre according to Test2 could be relevant.

To avoid worsening of the crown endurance for the tyre versions Test1 and Test2, the inventors increased the axial width of the hooping layers, thereby creating two new tyre versions Test3 and Inv1, respectively, Test3 being identical to Test1 except with regard to the axial width of the hooping layers, and similarly, Inv1 being identical to Test2 except with regard to the axial width of the hooping layers. The increase in the optimal axial width of the hooping layers for Test 3 and Inv 1 is 100 mm with respect to Test1 and Test2, respectively, on either side of the equatorial plane of the tyre, i.e. an increase in the axial width of the hooping layers of close to 30%. This increase remains acceptable with respect to the resistance to fatigue with respect to the reinforcing elements of the hooping layers. The maximum energy density is equivalent to the control for the tyre according to the invention version Inv1 but remains greater than 70% with regard to the control for the tyre according to Test 3, with the widened hooping layer, this not always being sufficient in terms of endurance. The inextensible reinforcing elements of the control tyre do not allow an increase in axial width of the hooping layers without a significant worsening of endurance.

From this point of view, the inventors expect an endurance performance at least equal to that of the control for the better version of the invention, namely the version Inv1 with hooping layers widened by 100 mm on either side of the equatorial plane.

The invention therefore makes it possible to improve the impact resistance of the crowns of construction plant tyres comprising hooping layers having extensible reinforcing elements, and certain forms of uneven wear. The most accomplished version of the tyre with widened hooping layers also makes it possible to maintain an endurance of the rubber compositions at the ends of the working layers. All of these performance aspects demonstrate the advantage of the invention.

1.-6. (canceled)

7. A radial tire for a heavy-duty construction plant vehicle, the tire being adapted to be mounted on a nominal rim having a radius R expressed in inches, the radial tire comprising:
a tread;
a carcass reinforcement; and
a crown reinforcement, which is radially inside the tread and radially outside the carcass reinforcement and which comprises a working reinforcement and a hoop reinforcement,
wherein the working reinforcement comprises at least two working layers, each comprising reinforcing elements that:
are made of metal,
are coated in an elastomeric material,
are parallel to each other and form an angle at least equal to 18° and at most equal to 45° with a circumferential direction of the tire, the reinforcing elements being crossed from one working layer to another working layer, and
each have a structural elongation, a total elongation at break, and at least one tangent tensile modulus GT, each measured in accordance with the standard ASTM D 2969-04 of 2014,
wherein the at least two working layers include a smallest axial width working layer, which has an axial width LT in mm and the reinforcing elements of which have a linear density MT in g/m and are disposed in the smallest axial width working layer with a mean pitch PT in mm,
wherein the hoop reinforcement comprises at least two hooping layers, each comprising reinforcing elements that:
are made of metal,
are coated in an elastomeric material,
are parallel to each other and form with the circumferential direction angles having absolute values at least equal to 5° and at most equal to 16°,
each have a structural elongation, a total elongation at break, and at least one tangent tensile modulus, each measured in accordance with the standard ASTM D 2969-04 of 2014, and
have a metal linear density MF in g/m, a tangent modulus GF at 1.5% strain, and are disposed in the hooping layer with a mean pitch PF in mm, each hooping layer having a tangent linear stiffness RF equal to (GF*MF/7.8)/PF,
wherein each reinforcing element of each hooping layer is extensible, the structural elongation of each reinforcing element of each hooping layer being at most equal to 1% and at least equal to 0.3%, and the tangent linear stiffness RF at 1.5% strain of each reinforcing element of each hooping layer being at least equal to 75 KN/mm and at most equal to 160 KN/mm, and
wherein the at least two hooping layers include a radially outermost hooping layer, which has an axial width LF and the reinforcing elements of which have a structural elongation AsF, such that the axial width LF is at least equal to LT*[R/110.25+((GT/GF)*(MT/MF)/(PT/PF)+AsF*80-1)/8].

8. The radial tire according to claim 7, wherein each reinforcing element of each working layer is inextensible, the structural elongation of each reinforcing element of each working layer being at most equal to 0.2%, and the tangent modulus GT at 0.5% strain of each reinforcing element of each working layer being at least equal to 150 GPa.

9. The radial tire according to claim 7, wherein each reinforcing element of each working layer is extensible, the structural elongation of each reinforcing element of each working layer being at least equal to 0.3%, the tangent modulus GT at 1.5% strain of each reinforcing element of each working layer being at most equal to 130 GPa, and the total elongation at break of each reinforcing element of each working layer being at least equal to 2%.

10. The radial tire according to claim 7, wherein the at least two hooping layers include a smallest axial width hooping layer having an axial width LF at least equal to 0.9*LT*[R/110.25+((GT/GF)*(MT/MF)/(PT/PF)+AsF*100-1)/7] and at most equal to 1.1*LT*[R/110.25+((GT/GF)*(MT/MF)/(PT/PF)+AsF*100-1)/7].

11. The radial tire according to claim 7, wherein each hooping layer has an axial width at most equal to the axial width LT of the smallest axial width working layer.

12. The radial tire according to claim 7, wherein the radius R is at least equal to 57 inches.
